(19) United States
(12) Patent Application Publication
(10) Pub. No.: US 2014/0352622 A1
(43) Pub. Date: Dec. 4, 2014

(54) Raised litter tray enclosure with sliding sub-floor

(71) Applicants: Michael Walter Wallace, San Leandro, CA (US); Martha Lucero Wallace, San Leandro, CA (US)

(72) Inventors: Michael Walter Wallace, San Leandro, CA (US); Martha Lucero Wallace, San Leandro, CA (US)

(21) Appl. No.: 13/905,390

(22) Filed: May 30, 2013

(51) Int. Cl. A01K 1/01

(52) U.S. Cl. CPC A01K 1/0107
USPC 119/165

(57) ABSTRACT

A raised and sealed litter tray enclosure appropriate for placement indoors or connected to the exterior of a dwelling. The raised litter enclosure improves ergonomics during maintenance and cleaning by raising the litter tray/s and placing them on ball bearing drawer slides. The sealing of the litter tray to the floor of the enclosure limits odor transport; and for exterior mounted enclosures this seal prevents heat loss. The hinged subfloor allows for angular travel to unseal the litter tray and provides clearance for the subfloor assembly's opening travel.

### REFERENCES CITED

| | | |
|---|---|---|
| 7,530,331 | May 2009 | Malachowski |
| 10/852,463 | May 2004 | Ricke |
| 5,975,017 | November 1999 | Cameron |
| 08/588,016 | January 1996 | Richey |
| 13/385,227 | February 1992 | Omps |

### BACKGROUND OF THE INVENTION

1. Field of the Invention

This invention pertains to the field of animal accessories and more specifically to a new and improved means to enclose litter trays while providing convenient, ergonomically appropriate access for cleaning by means of a sliding sub-floor.

2. Brief Description of the Prior Art

Small animals, such as cats, are popular pets and often live indoors or in a combination of indoors and outdoors. Typically households maintain litter boxes for the collection of pet elimination deposits and the disposal thereof. Prior Art shows many examples and designs for litter trays, boxes, and enclosures. Most are maintained on the floor of dwellings or in cabinet-type enclosures where the litter trays require significant bending and lifting for an average person to access the litter tray (Omps, Richey). Some examples of Prior Art place the litter trays outside of the house; however the means for access to the litter tray for sifting and cleaning remains complicated or difficult by being out-of-reach for the pet owner (Cameron, Malachowski).

Therefore, a need exists to provide a raised litter tray enclosure by which litter can be contained and easily accessed by the pet for use and by pet owners for sifting and cleaning. A raised litter tray enclosure is needed for outdoor enclosures as well as indoor enclosures.

### SUMMARY OF THE INVENTION

The primary object of the invention is to allow human access to clean and manage pet litter trays, while housing the litter trays in a sanitary pet-accessible enclosure, by means of a sliding sub-floor that is at a height that allows for convenient, ergonomically appropriate access.

Another object of the invention is to provide a novel and improved means to manage litter trays that are housed in an exterior enclosure—or shed-like housing—that is easily accessible to indoor animals.

Another object of the invention is to provide a private, safe, and sanitary enclosure for domestic pets such as cats in which the animals can easily cover their elimination deposits with litter without scattering the litter.

A further object of the invention is that with the improved access to the litter trays for cleaning and maintenance, the litter will be more effective, thus minimizing odors from the litter trays.

The invention comprises a generally rectangular enclosure surmounted by a roof, and mounted on a durable frame that raises the litter enclosure above the floor or ground. The enclosure has a double floor, with a sliding sub-floor that contains removable litter trays that can be kept separate from the primary floor of the enclosure. The litter trays in the subfloor align with holes in the enclosure floor and slides on ball-bearing drawer slides to easily pull out the full length of the litter trays for sifting and cleaning. The enclosure has a secure door for pet owner access to clean the interior of the enclosure, as well as a wall opening for pet access to the enclosure.

This invention can be applied to either indoor or outdoor litter enclosures. The invention allows the enclosure to be outside, built adjacent to a primary dwelling—with access to the litter trays for indoor pets without exposure to the exterior environment.

### BRIEF DESCRIPTION OF THE DRAWINGS

The advantages of the invention will be apparent from the following detailed description taken in conjunction with the accompanying drawings wherein all like numerals depict like parts.

FIG. 1 Perspective view of invention.

FIG. 2 Cutaway side view of invention showing subfloor assembly closed, sealed and locked.

FIG. 3 Cutaway side view of invention showing subfloor assembly closed, unsealed and unlocked.

FIG. 4 Cutaway side view of invention showing subfloor assembly opened, unsealed and unlocked.

### DETAILED DESCRIPTION OF THE INVENTION

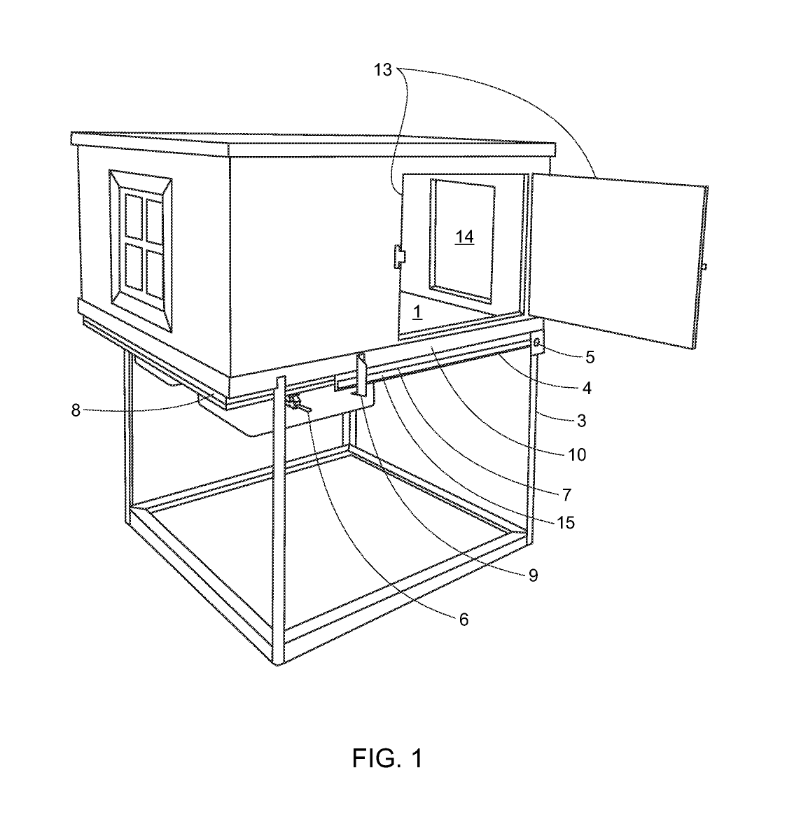

Referring to FIG. 1 the raised litter tray enclosure consists of a structure constructed of materials commonly used in domicile and shed construction (e.g. wood, plastic, stucco, etc.) surmounting a generally rectangular support frame (3) constructed of framing material (e.g. steel, aluminum, wood, plastic, etc.) defining a space dimensioned to support the litter tray enclosure and raising it to a height that allows for convenient ergonomically appropriate access to the interior of the enclosure and litter trays. The raised litter tray enclosure will be dimensioned and configured to be used indoors or outdoors and with one or more litter trays. As shown in FIG. 1 the litter tray enclosure is defined by four generally planar walls, a top panel forms a ceiling. The floor (1) and a subfloor (8) complete the enclosure. One accessible wall will have a lockable door opening (13) to allow access for cleaning the interior of the enclosure. Another wall will have an opening (14) to allow access to the enclosure by the pet.

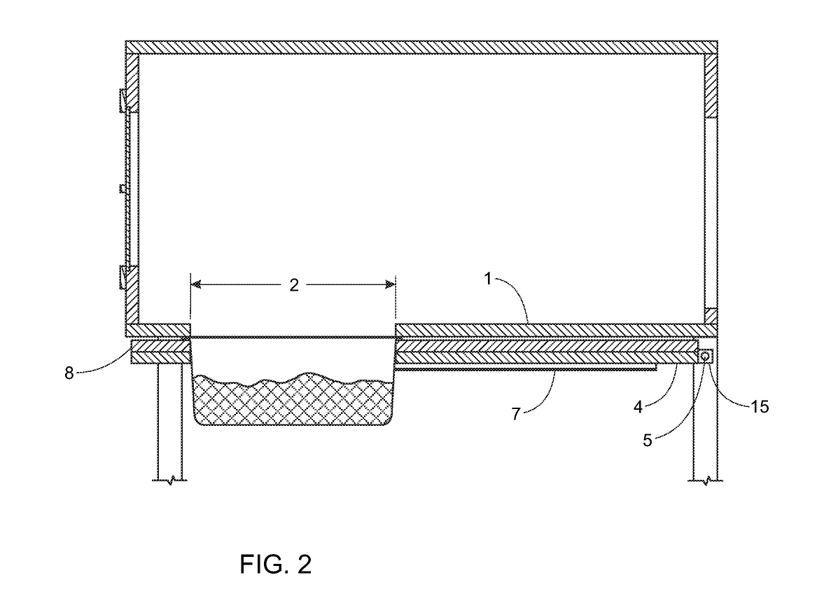

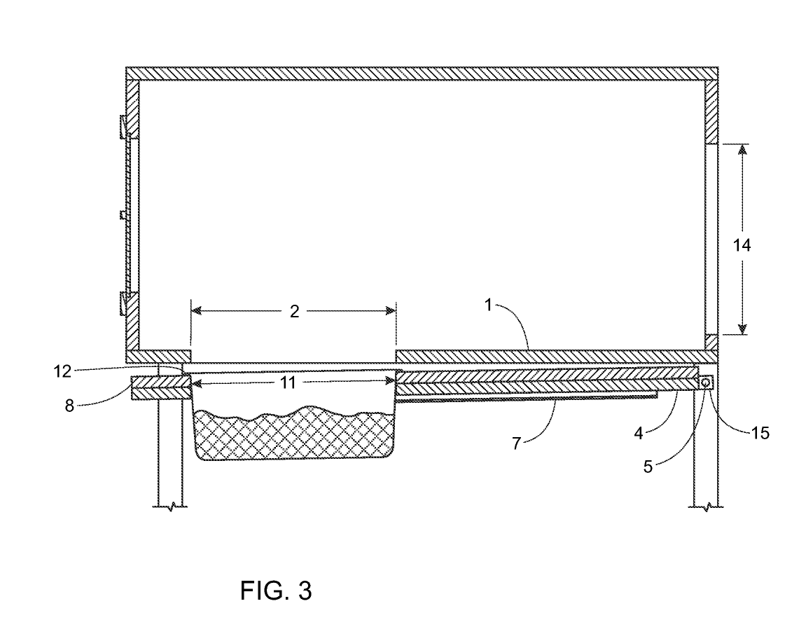

As shown in FIGS. 2, 3 and 4 an opening or openings (2) in the litter enclosure floor (1) aligns with an opening (11) in the subfloor (8). These openings will be dimensioned to accept commercially available litter trays. The perimeter of the opening (11) in the subfloor (8) will be provided with a compressible sealing material, either the upper flange of the litter tray or compressible gasket in the case of a flush mounted litter tray.

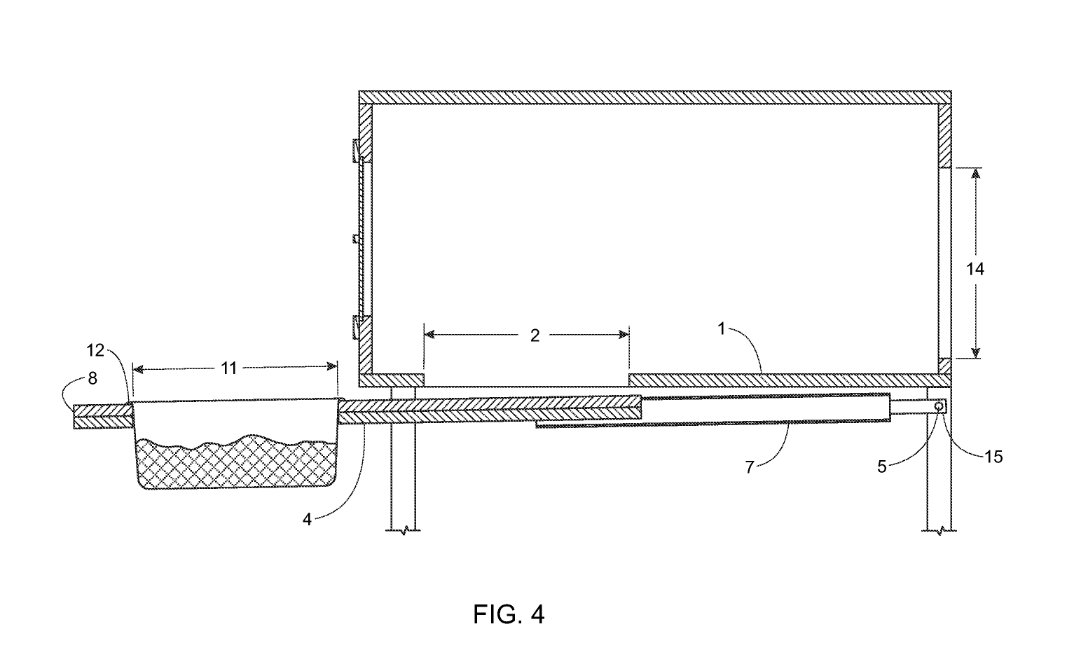

Referring to FIG. 1 and FIG. 4 the subfloor (8) is bolted to subfloor frame (4) on which it rests. The subfloor frame (4) is in turn bolted to the inner rail of the drawer slide (7). The outer rail of the drawer slide (7) is bolted to the hinge bar (15). The complete subfloor (8), subfloor frame (4), drawer slide (7) and hinge bar assembly pivot down from the floor of the enclosure by means of the hinge pivot (5). This complete subfloor assembly is raised, lowered and the sealing gasket compressed by standard commercially available toggle locks. The angular travel of the complete subfloor (8), subfloor frame (4), drawer slide (7) and hinge bar assembly is limited by the adjustable stop (9). The angular travel of the subfloor assembly (4), (7), (8) decompresses the seal (12) between the subfloor (8) and the floor of the enclosure (1) allowing the subfloor (8) to travel from beneath the litter tray enclosure allowing access to the litter trays for cleaning as in FIG. 4.

It is understood that the embodiment of the litter enclosure as described and/or illustrated in no way limits are defines possible embodiments of this invention.

What is claimed is:

1. A raised pet litter enclosure comprising:
a) A generally rectangular enclosure with four planar walls, surmounted by a roof, and mounted to a bottom floor panel, generally defining an interior space; and
b) Said floor panel having at least one opening approximating the size of standard commercial litter trays; and
c) Said enclosure mounted on a generally vertical support frame connected to a hinged sub-frame; and
d) Said enclosure surmounts a sliding drawer sub-floor with openings aligning with said floor panel openings and mounting to said hinged sub-frame, by means of ball bearing drawer slides.

2. Said sliding drawer sub-floor as claimed in claim 1 having openings which will receive standard commercial litter trays, and support said trays by the surrounding reinforcing top lip of the litter tray.

3. Said openings in the said sub-floor as claimed in claim 1 providing animals means to access the litter trays from the said interior space.

4. Said openings in sub-floor as claimed in claim 1 containing a sealing device to seal interior space as claimed in claim 1 from the external environment.

5. The angular travel of the hinged sub-frame as claimed in claim 1 being limited by an adjustable stop mounted on the vertical support frame as claimed in claim 1.

6. Said hinged sub-frame as claimed in claim 1 being raised and locked by toggle lock mounted on the vertical support frame as claimed in claim 1.

7. Sliding drawer sub-floor supported by the hinged sub-frame as claimed in claim 1 being able to travel on said drawer slides at least the length necessary to expose the litter trays allowing human access for cleaning and removing litter trays.

8. A securable door like opening in at least one of the planar walls as claimed in claim 1 allowing access to the interior space as claimed in claim 1 for cleaning of said interior space.

9. An opening in one of the planar walls of enclosure as claimed in claim 1 allowing animal access to the interior of said enclosure.

10. Said enclosure is appropriate for placement indoors or connected to the exterior of a dwelling.
